(19) United States
(12) Patent Application Publication
(10) Pub. No.: US 2026/0194106 A1
(43) Pub. Date: Jul. 9, 2026

(54) BUSHING ARRANGEMENT FOR A SUSPENSION COMPONENT

(71) Applicant: SRAM, LLC, CHICAGO, IL (US)

(72) Inventors: CHI-HUI SU, TAICHUNG CITY (TW); CHEN-HSIUNG CHEN, TAICHUNG CITY (TW); CHU CHEN WANG, TAICHUNG CITY (TW); MICHAEL VAN ZYL, COLORADO SPRINGS, CO (US)

(73) Assignee: SRAM, LLC, CHICAGO, IL (US)

(21) Appl. No.: 19/440,880

(22) Filed: Jan. 6, 2026

Related U.S. Application Data
(60) Provisional application No. 63/742,935, filed on Jan. 8, 2025.

(51) Int. Cl. F16C 33/10; F16C 27/02

(52) U.S. Cl. CPC F16C 33/1065; F16C 27/02; F16C 2326/26

(57) ABSTRACT

A bushing includes a bushing body. The bushing body substantially surrounds an axis, and has an inner surrounding surface, and an outer surrounding surface that is opposite to the inner surrounding surface. The inner surrounding surface of the bushing body has an inner structure that includes a plurality of inner radial protrusions and a plurality of inner radial recesses. The inner radial protrusions and the inner radial recesses are arranged along the axis in an alternating arrangement. The inner radial protrusions cooperatively form an inner contact interface.

This application claims the benefit of U.S. Provisional Patent Application 63/742,935, filed January 8, 2025, which is hereby incorporated by reference in its entirety.

### FIELD

The disclosure relates to suspension components for bicycles, and more particularly to a bushing arrangement for a suspension component.

### BACKGROUND

Bicycles may have suspension components. The suspension components advantageously reduce transmission of shocks and/or vibrations to a rider when riding over a bump or obstacle. However, undue friction and wear may result from mismatched dimensions or tolerances during assembly of the suspension components. Conventionally, controlling tolerances of the elements of the suspension components, for example, repeatedly machining the elements of the suspension components, is costly. Accordingly, it is advantageous to provide a suspension arrangement that facilitates easy and reliable assembly of suspension components that alleviate problems of mismatched dimensions or tolerances.

### SUMMARY

Therefore, an object of the disclosure is to provide a bushing that can alleviate drawbacks of the prior art.

According to the disclosure, the bushing includes a bushing body. The bushing body is disposed about an axis, and has an inner surrounding surface, and an outer surrounding surface that is opposite to the inner surrounding surface. The inner surrounding surface of the bushing body has an inner structure that includes a plurality of inner radial protrusions and a plurality of inner radial recesses. The inner radial protrusions and the inner radial recesses are arranged along the axis in an alternating arrangement. The inner radial protrusions cooperatively form an inner contact interface.

Another object of the disclosure is to provide a suspension arrangement for a bicycle that can alleviate drawbacks of the prior art.

According to one aspect of the disclosure, the suspension arrangement is adapted to facilitate relative movement, and has a first suspension element, a second suspension element and a bushing body. The second suspension element is movable along an axis within at least a portion of the first suspension element. The bushing body is disposed between the first suspension element and the second suspension element. The bushing body has an inner surrounding surface, and an outer surrounding surface that is opposite to the inner surrounding surface. The outer surrounding surface of the bushing body has an outer structure that includes a plurality of outer radial protrusions and a plurality of outer radial recesses. The outer radial protrusions and the outer radial recesses are arranged along the axis in an alternating arrangement. The outer radial protrusions cooperatively form an outer contact interface. The outer contact interface is in contact with the first suspension element.

According to another aspect of the disclosure, the suspension arrangement includes a first suspension element, a second suspension element, a first bushing and a second bushing. The first suspension element has an interior wall defining an interior volume between a first end and a second end thereof. The second suspension element is movable along an axis at least in part within the interior volume of the first suspension element. The first bushing is disposed between the first suspension element and the second suspension element. The first bushing includes at least one flexible first bushing clearance element facilitating radial movement relative to the axis between the first suspension element and the second suspension element. The second bushing is disposed between the first suspension element and the second suspension element, and is spaced apart between the first bushing and the second end of the first suspension element. The second bushing includes at least one flexible second bushing clearance element facilitating radial movement relative to the axis between the first suspension element and the second suspension element.

### BRIEF DESCRIPTION OF THE DRAWINGS

Other features and advantages of the disclosure will become apparent in the following detailed description with reference to the accompanying drawings. It is noted that various features may not be drawn to scale.

FIG. 1 is a side view of an example of a bicycle.

FIG. 2 is a front view of an example suspension front fork that may be employed with the example bicycle of FIG. 1.

FIG. 3 is a perspective view of an example bushing that may be employed with the example suspension front fork of FIG. 2.

FIG. 4 is a perspective view of an example lower tube assembly that may be employed with the example suspension front fork of FIG. 2.

FIG. 5 is a top view of the example lower tube assembly in FIG. 4.

FIG. 6 is a rear sectional view of the example lower tube assembly taken along line VI-VI in FIG. 5.

FIG. 7 is an enlarged view of the circled region VII in FIG. 6.

FIG. 8 is a rear sectional view of the example lower tube assembly of FIG. 4 mounted with example bushings.

FIG. 9 is an enlarged view of the circled region IX in FIG. 8.

FIG. 10 is a partial rear sectional view of example lower tubes and example upper tubes mounted with example bushings.

FIG. 11 is an enlarged view of the circled region XI in FIG. 10.

FIG. 12 is a partial sectional view of an example bushing before being assembled with suspension components.

FIG. 13 is a partial sectional view of the example bushing in FIG. 12 after being assembled with suspension components.

The figures may not be to scale. Instead, the thickness of the layers or regions may be enlarged in the drawings. In general, the same reference numbers will be used throughout the drawing(s) and accompanying written description to refer to the same or like parts.

Other aspects and advantages of the embodiments disclosed herein will become apparent upon consideration of the following detailed description, wherein similar or identical structures may have similar or identical reference numerals.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

The word “exemplary” is used herein to mean “serving as an example, instance, or illustration.” Any implementation described herein as “exemplary” is not necessarily to be construed as preferred or advantageous over other implementations.

The descriptors used herein, including the terms “first”, “second”, “third”, etc. may be used interchangeably to distinguish one component from another and are not intended to signify location or importance of the individual components. Unless otherwise specified or understood based on their context of use, such descriptors are not intended to impute any meaning of priority or ordering in time but merely as labels for referring to multiple elements or components separately for ease of understanding the disclosed examples. In some examples, the descriptor "first" may be used to refer to an element in the detailed description, while the same element may be referred to in a claim with a different descriptor such as "second" or "third." In such instances, it should be understood that such descriptors are used merely for ease of referencing multiple elements or components.

The terms “coupled,” “fixed,” “attached to,” and the like refer to both direct coupling, fixing or attaching, as well as indirect coupling, fixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Various suspension components may be provided with reference to the following disclosure. For example, front suspension forks, rear suspension shocks, seatposts, and various other suspension components are contemplated in connection with the features that follow. Proceeding with the example of front suspension on a bicycle, a front fork typically includes a crown, a steerer tube extending upward from the crown, and two legs extending downward from the crown. Each leg has an upper tube that is connected to the crown and a lower tube that is to be connected to the front wheel. The upper and lower tubes are arranged in a telescopic relationship. In some instances, a damper is disposed in one of the legs and a spring (e.g., an air spring, a coil spring) is disposed in the other leg. The spring enables the front fork to compress or contract when riding over a bump or obstacle, thereby reducing the transmission of shocks and vibrations to the rider, and then returns the fork to an expanded state after the compressive force is removed.

A conventional bicycle suspension component may include a first tube, a second tube having an insertion portion that is movable along an axis within the first tube, and a plurality of bushings disposed between the first tube and the insertion portion of the second tube. Specifically, each of the bushings has an inner cylindrical surface that is in slidable contact with an outer surface of the insertion portion of the second tube, and an outer cylindrical surface that is opposite to the inner cylindrical surface and that is coupled to an inner surface of the first tube. The fit between the inner surface of the first tube and the outer cylindrical surface of each of the bushings is a press fit (also referred to as an interference fit). As each of the bushings is press fit into the first tube, deformation may occur. For example, since the configuration of the outer cylindrical surface leads to low flexibility in a radial direction, each of the bushings may deform such that the inner cylindrical surface thereof is significantly twisted or bent. As such, the inner cylindrical surface of each of the bushings may not be aligned with the outer surface of the insertion portion of the second tube along the axis, and an effective inner diameter of each of the bushings may be reduced. As a result, each of the bushings may not be able to facilitate smooth relative movement between the first tube and the second tube, and may need to undergo additional processes, for example a reaming process.

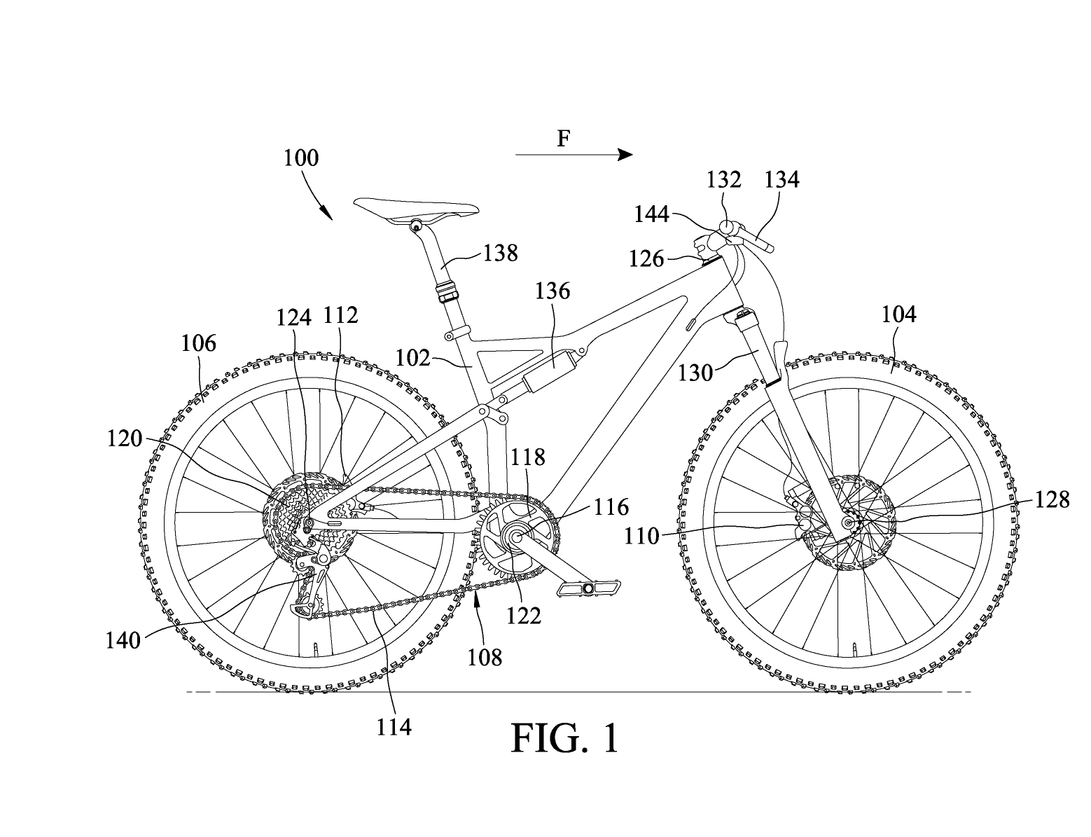

FIG. 1 illustrates an example bicycle 100 that includes a main frame 102, a front wheel 104, a rear wheel 106, and a drivetrain 108. The front wheel 104 and the rear wheel 106 are rotatably connected to the main frame 102. In the illustrated example, the bicycle 100 further includes a braking system that includes a front brake 110 and a rear brake 112 for respectively braking the front wheel 104 and the rear wheel 106. In the illustrated example, the drivetrain 108 includes a chain 114, a crank assembly 116 rotatably mounted to the main frame 102, a front sprocket assembly 118 coaxially mounted to the crank assembly 116, and a rear sprocket assembly 120 coaxially mounted to the rear wheel 106. Each of the front sprocket assembly 118 and the rear sprocket assembly 120 includes at least one sprocket. The direction of arrow (F) in FIG. 1 indicates a forward direction of movement for the bicycle 100.

In the illustrated example, the bicycle 100 includes a bottom bracket 122, a rear wheel hub 124, a headset 126, and a front wheel hub 128. The bottom bracket 122 is mounted to a bottom portion of the main frame 102, and supports the crank assembly 116 relative to the main frame 102. The rear wheel hub 124 is mounted to a rear portion of the main frame 102, and supports the rear wheel 106 and the rear sprocket assembly 120 relative to the main frame 102. The headset 126 is mounted to a front portion of the main frame 102. In the illustrated example, the front wheel 104 is coupled to the front portion of the main frame 102 via a front fork 130 that is rotatably mounted to the headset 126. The front wheel hub 128 is mounted to a bottom portion of the front fork 130, and supports the front wheel 104 relative to the front fork 130. The bicycle 100 may further have a handlebar 132 that is connected to and rotatable with the front fork 130. In some examples, the front fork 130 may be configured as a suspension fork. In some examples, the bicycle 100 may have a rear shock absorber 136 for damping rear shock and/or a dropper seat post 138.

In the illustrated example of FIG. 1, the bicycle 100 may have a single-speed drivetrain or a multi-speed drivetrain which has a shifting system. For example, the bicycle 100 may have a multiple-geared drivetrain 108 that may have one or both of a front gear changer (described further below as a front shifting system) and a rear gear changer mounted to the main frame 102. The gear changers may be mechanical or electromechanical derailleurs, internal gear systems, for example front gearboxes and/or rear internal gear hubs including planetary gearing. The illustrated example includes a rear derailleur 140 without a front shifting system, but it should be appreciated that any combination of gear changers is contemplated. The gear changers can be operated using one or more gear shifters 144, which may be mounted to the handlebar 132. The gear shifters 144 may operate the gear changers through wired or wireless signal communication, or via a physical connection using a mechanical shift cable or hydraulic line. The bicycle 100 as described above and shown in FIG. 1 is a full-suspension mountain bike with a flat handlebar. Those having ordinary skill in the art should recognize that the type and style of bicycle may vary from the disclosed example. For example, a road bicycle with drop-style handlebars, along with a drivetrain having road type gearing with a road gear range may be used instead of a mountain bike or other bicycle gear range, or an e-bike with an integrated electric motor used to assist propulsion.

In this example, the bicycle 100 includes brake system. The brake system includes at least one brake lever 134 that is movably connected to the handlebar 132. The brake lever 134 is configured to operate components of the brake system of the bicycle 100. In one example, the brake system can include one or both of a hydraulic or cable actuated front brake mechanism coupled to the front wheel 104 via a hydraulic line or mechanical cable and a hydraulic or cable actuated rear brake mechanism coupled to the rear wheel 106 through a hydraulic line or mechanical cable. As noted above, the brake system can be a hydraulically actuated system or a mechanically actuated system.

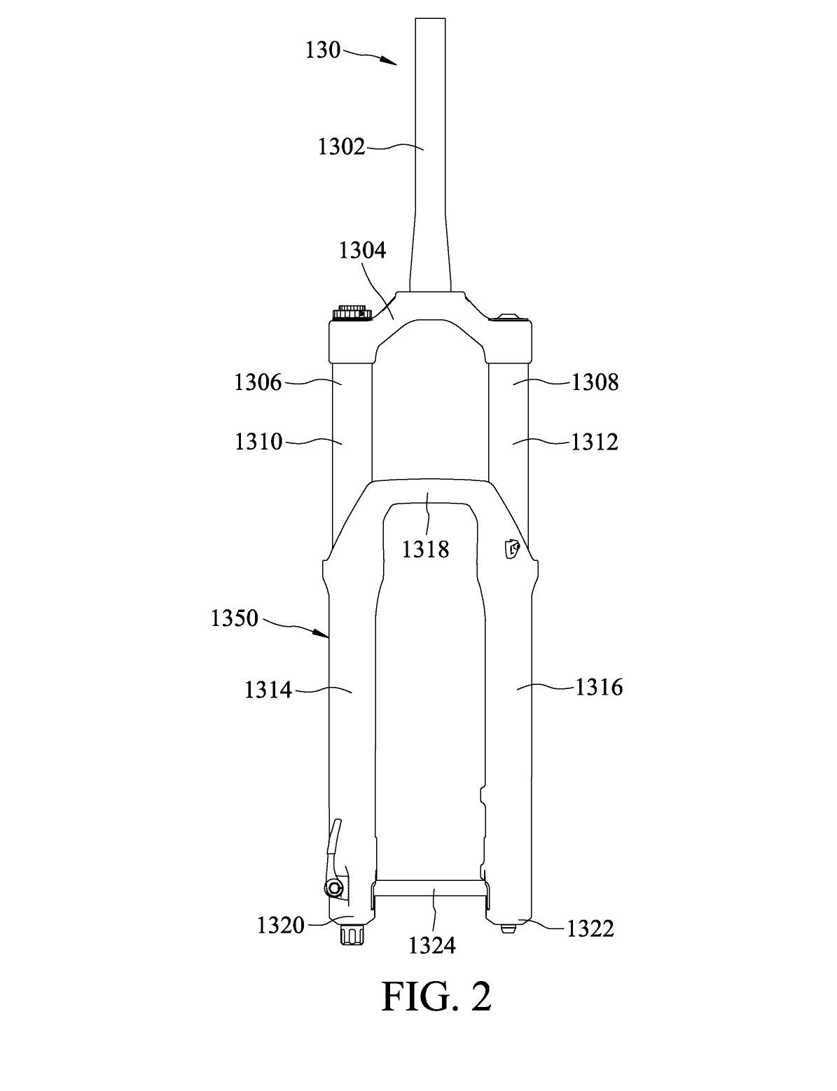

FIG. 2 is a front view of an example suspension front fork. In the illustrated example, the front fork 130 includes a steerer tube 1302, a crown 1304, a first leg 1306, and a second leg 1308. The steerer tube 1302 is coupled to and extends upward from the crown 1304. The first and second legs 1306, 1308 are coupled to and extend downward from the crown 1304. The steerer tube 1302 is coupled to and rotatable with the crown 1304. For example, the steerer tube 1302 may be pressed, keyed, bonded, or otherwise attached with the crown 1304. In an embodiment, the steerer tube 1302 is formed with the crown 1304, for example as a unitary component.

In the illustrated example in FIG. 2, each of the first and second legs 1306, 1308 include an upper tube 1310, 1312 and a lower tube 1314, 1316. The upper tubes 1310, 1312 of the first and second legs 1306, 1308 may cooperatively form an upper tube assembly. The lower tubes 1314, 1316 of the first and second legs 1306, 1308 may cooperatively form a lower tube assembly 1350. The upper tubes 1310, 1312 of the first and second legs 1306, 1308 are coupled to and extend from the crown 1304. In some examples, the lower tubes 1314, 1316 of the first and second legs 1306, 1308 may be coupled together via a fork brace 1318. As shown, the fork brace 1318 may be formed as a unitary element with the lower tubes 1314, 1316, but it should be appreciated that the fork brace 1318 may be separately provided, for example as an element removable from the lower tubes 1314, 1316. In some examples, the lower tubes 1314, 1316 of each of the first and second legs 1306, 1308 may include a front wheel attachment portion 1320, 1322 through which an example axle 1324 extends for mounting the front wheel 104 (see FIG. 1).

In various examples, the upper tubes 1310, 1312 and the lower tubes 1314, 1316 may define telescopic relationships. For example, the upper tubes 1310, 1312 may be telescopically received within the lower tubes 1314, 1316. In another example, referred to as an upside-down configuration, the lower tubes 1314, 1316 may be telescopically received within the upper tubes 1310, 1312.

In the example of FIG. 2, the upper tubes 1310, 1312 of the first and second legs 1306, 1308 are respectively slidably received within the lower tubes 1314, 1316 of the first and second legs 1306, 1308. Specifically, each of the lower tubes 1314, 1316 of the first and second legs 1306, 1308 has an interior wall that defines an interior volume therein. Each of the upper tubes 1310, 1312 of the first and second legs 1306, 1308 is movable at least in part within the interior volume of the respective one of the lower tubes 1314, 1316. Thus, each of the upper tubes 1310, 1312 forms a telescopic arrangement with the respective one of the lower tubes 1314, 1316. During a compression stroke, the upper tubes 1310, 1312 respectively move into or toward the lower tubes 1314, 1316. During a rebound stroke, the upper tubes 1310, 1312 respectively move out of or away from the lower tubes 1314, 1316.

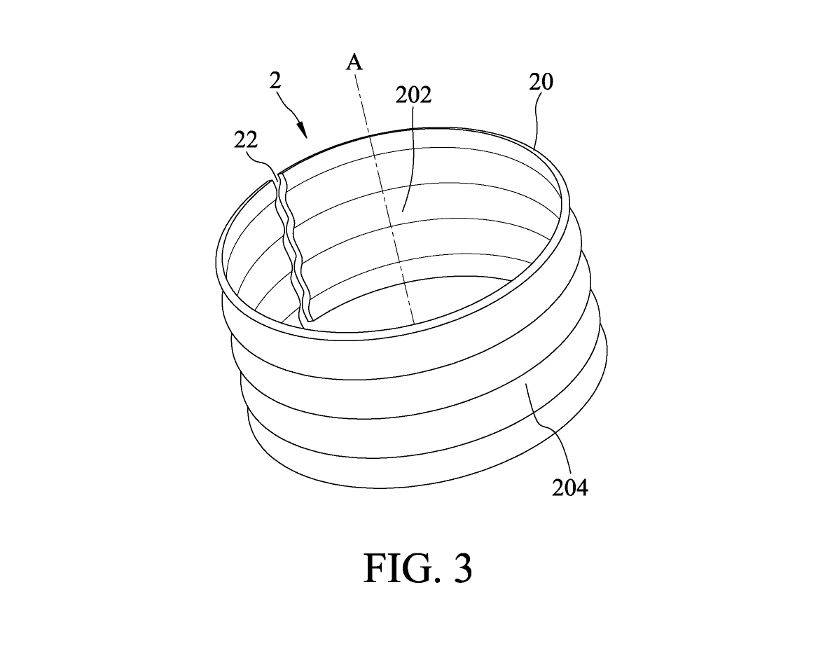

FIG. 3 is a perspective view of an example bushing. In the illustrated example, the bushing 2 includes a bushing body 20. The bushing body 20 may be annularly disposed about an axis (A). For example, the bushing body 20 may circumscribe more than 50% of a circumference centered at the axis (A). As such, when the example bushing 2 is mounted between two suspension elements to facilitate smooth relative movement, the suspension elements may be able to be steadily positioned relative to each other. In some examples, the bushing body 20 may circumscribe at least 75% of a circumference centered at the axis (A). In some examples, the bushing body 20 may circumscribe at least 90% of a circumference centered at the axis (A).

The bushing body 20 may have an inner surrounding surface 202 and an outer surrounding surface 204 opposite to the inner surrounding surface 202.

In some examples, the bushing body 20 may further have a slot 22 formed through the inner surrounding surface 202 and the outer surrounding surface 204. Specifically, the slot 22 is defined between two opposite circumferential ends of an example bushing body 20 that is configured not to completely surround the axis (A). The slot 22 serves to provide flexibility of the bushing 2 in a circumferential direction, so as to facilitate adjustment of the diametrical dimension of the bushing 2. In some examples, the slot 22 of the bushing body 20 may extend in an axial direction relative to the axis (A). In some examples, the slot 22 of the bushing body 20 may extend in direction oblique to the axis (A). In some examples, the slot 22 of the bushing body 20 may not be linear, and may in the shape of a polyline, a curve, or any plane figure.

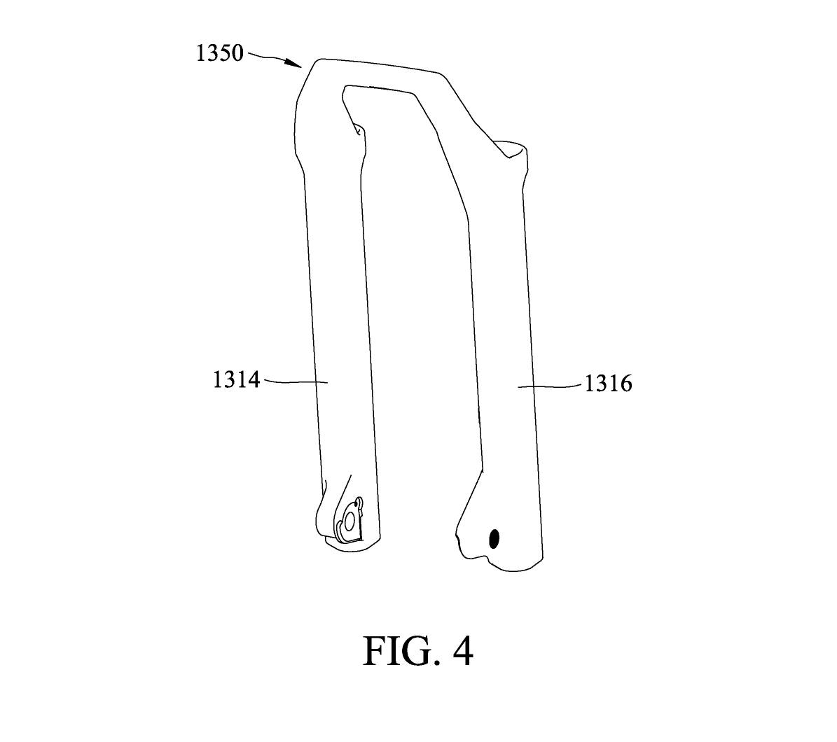

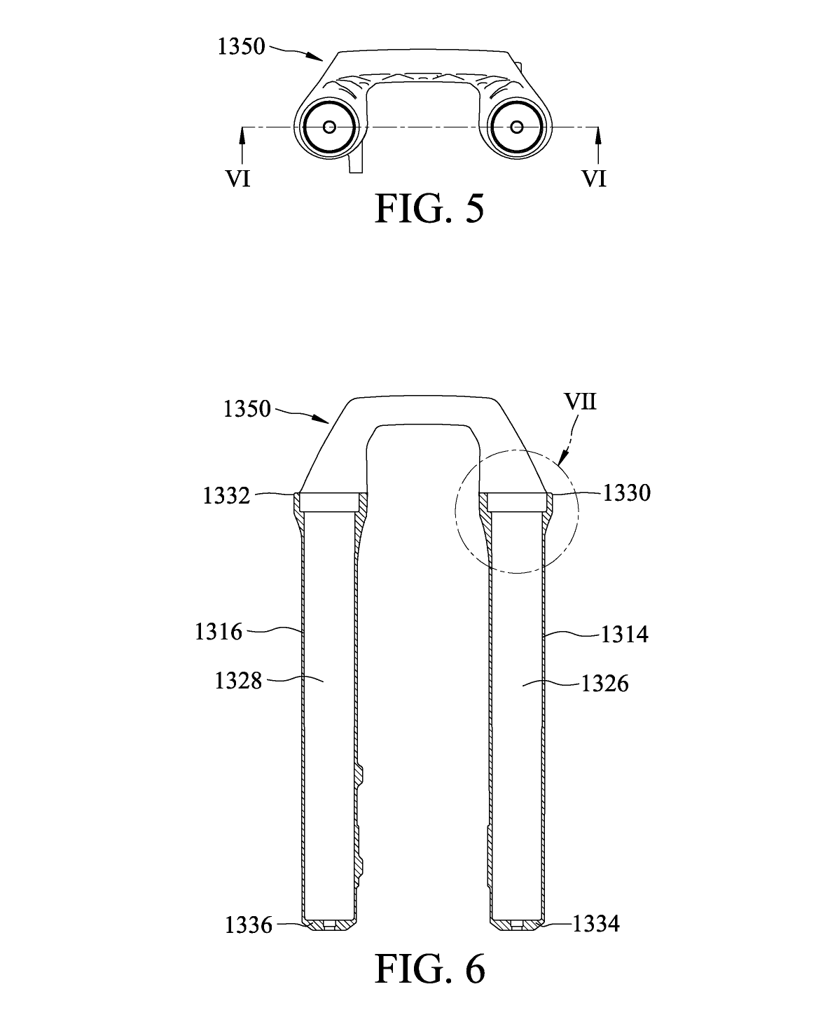

FIGS. 4 and 5 are respectively perspective and top views of an example lower tube assembly 1350. In some examples, one of the lower tubes 1314, 1316 may be provided with a spring therein (e.g., an air spring or a coil spring). The other one of the lower tubes 1314, 1316 may be provided with a damper therein that controls fluid flows to control compression and extension (rebound) of an example fork. In some examples, the damper and the spring may be combined into the same leg, for example with single-leg forks. A brake mount to which a brake caliper is mounted is typically provided on the one of the lower tubes 1314, 1316 with the spring, but this could be reversed or two brake mounts could be provided on both of the lower tubes 1314, 1316.

FIG. 6 is a rear sectional view of the example lower tube assembly 1350 including the lower tubes 1314, 1316. In the illustrated example, each of the lower tubes 1314, 1316 has an interior wall defining an interior volume 1326, 1328 between a first end 1330, 1332 and a second end 1334, 1336 thereof.

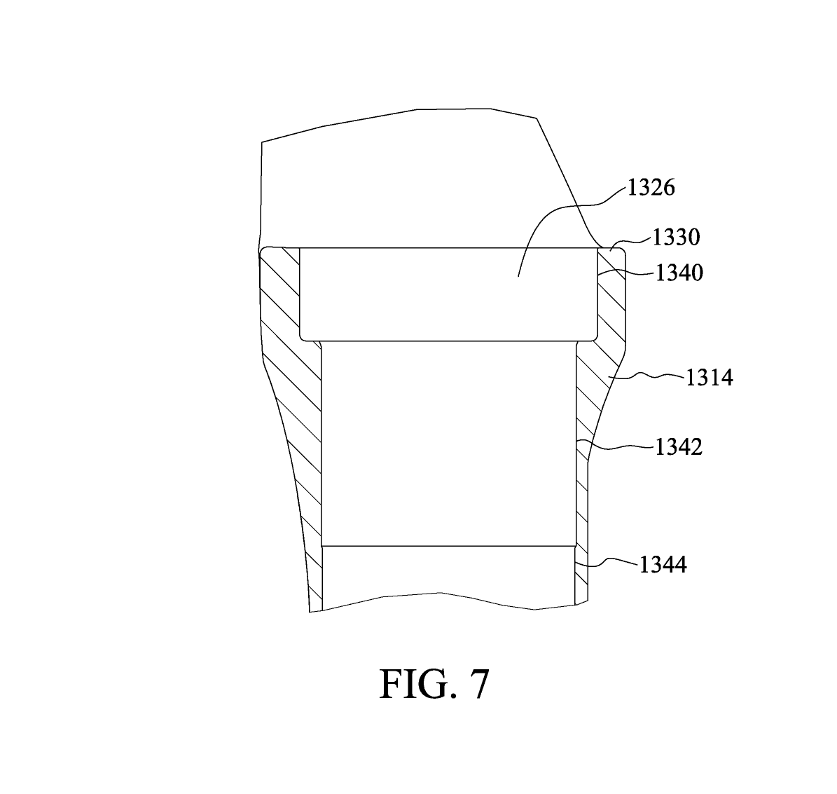

FIG. 7 is an enlarged view of FIG. 6. In some examples, the interior volume 1326 of the lower tube 1314 may be configured as a stepped hole. For example, the interior volume 1326 of the lower tube 1314 may include a first section 1340 that is disposed adjacent to the first end 1330, a second section 1342 that is connected to an end of the first section 1340 distal from the first end 1330, and a third section 1344 that is connected to an end of the second section 1342 distal from the first section 1340. In some examples, the inner stepped structure of the lower tube 1314 may be formed by, for example, casting, drilling, or other machining processes.

In some examples, the second section 1342 may have a diameter smaller than the diameter of the first section 1340. The third section 1344 may have a diameter smaller than the diameter of the second section 1342. The second section 1342 may be shaped and sized for a bushing to be mounted thereto. The first section 1340 may be shaped and sized for a lubrication feature and/or seal member (e.g., foam oil ring or dust wiper seal) to be mounted thereto.

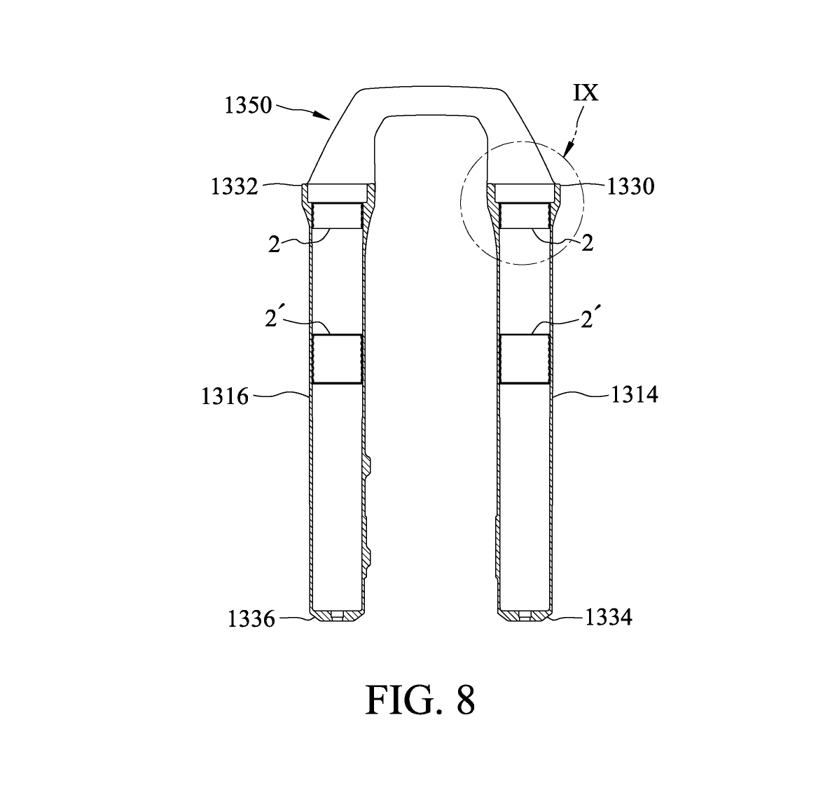

FIG. 8 is a rear sectional view of the example lower tube assembly 1350 mounted with a plurality of bushings. Specifically, each of the lower tubes 1314, 1316 is mounted with a first bushing 2 and a second bushing 2’ (e.g., an upper bushing and a lower bushing). In the illustrated example, for each of the lower tubes 1314, 1316, the upper bushing 2 may be proximate to the first end 1330, 1332 thereof. The lower bushing 2’ is spaced apart between the upper bushing 2 and the second end 1334, 1336 thereof.

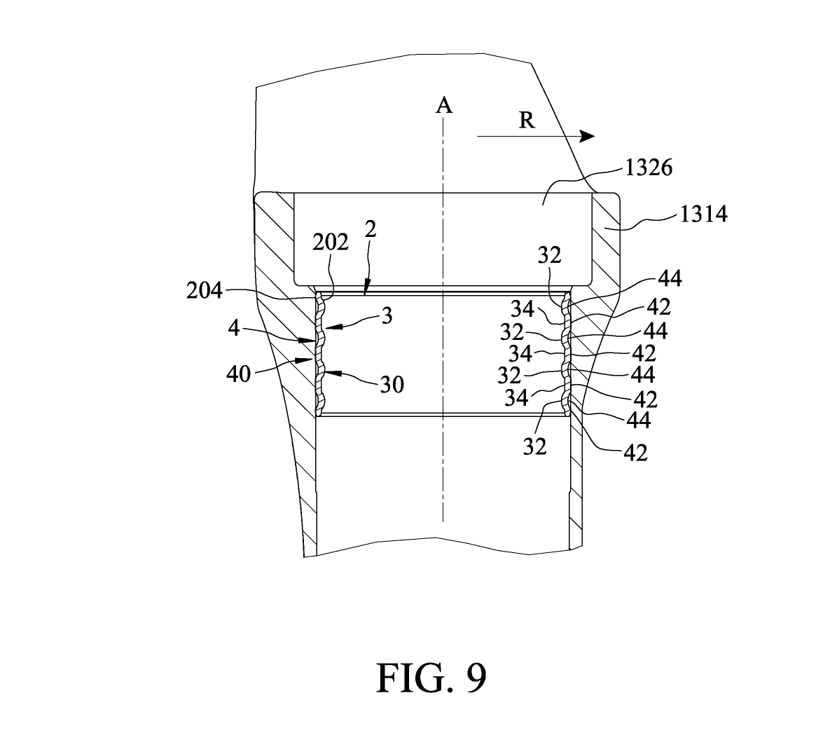

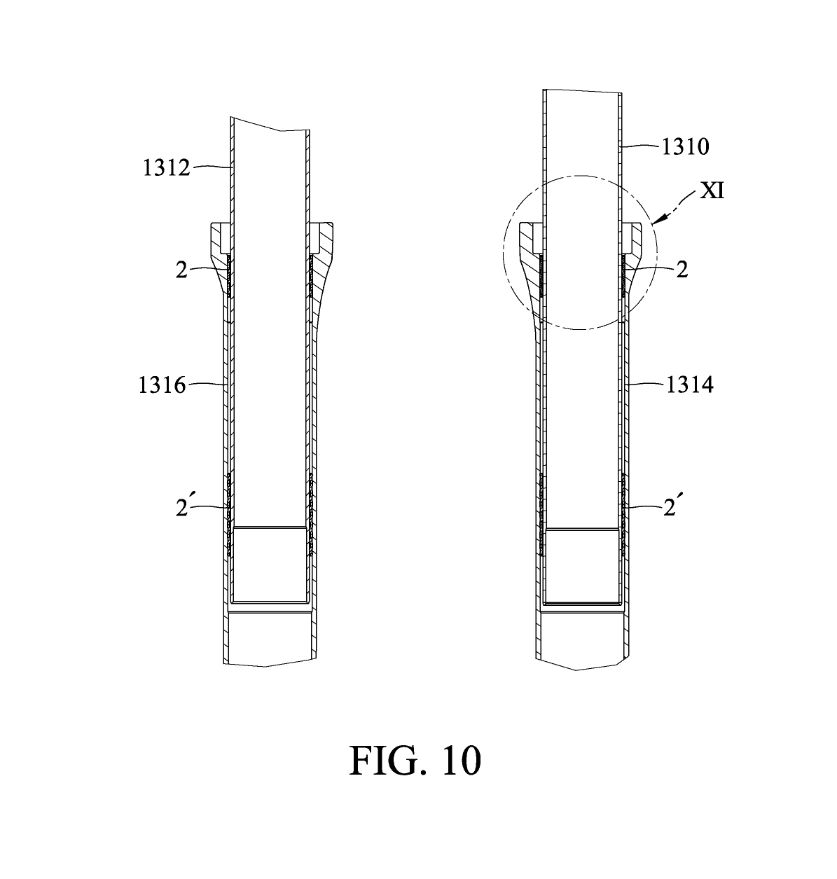

FIG. 9 is an enlarged view of FIG. 8. In some examples, the inner surrounding surface 202 of the example bushing 2 may have an inner structure 3 that includes a plurality of inner radial protrusions 32 and a plurality of inner radial recesses 34. The inner radial protrusions 32 and the inner radial recesses 34 may be arranged along the axis (A) in an alternating arrangement. The inner radial protrusions 32 cooperatively form an inner contact interface 30 for contact with an upper tube.

In some examples, each of the inner radial protrusions 32 may extend circuferentially about the axis (A). In some examples, each of the inner radial protrusions 32 may extend helically about the axis (A).

In some examples, the inner structure 3 may be configured as a wavy structure that includes a plurality of wave crests respectively serving as the inner radial protrusions 32, and a plurality of wave troughs respectively serving as the inner radial recesses 34.

In some examples, the outer surrounding surface 204 of the example bushing 2 may have an outer structure 4 that includes a plurality of outer radial protrusions 42 and a plurality of outer radial recesses 44. The outer radial protrusions 42 and the outer radial recesses 44 are arranged along the axis (A) in an alternating arrangement. The outer radial protrusions 42 cooperatively form an outer contact interface 40 for contact with the example lower tube 1314.

In some examples, each of the outer radial protrusions 42 may extend circumferentially about the axis (A). In some examples, each of the outer radial protrusions 42 may extend helically about the axis (A).

In some examples, the outer structure 4 may be configured as a wavy structure that includes a plurality of wave crests respectively serving as the outer radial protrusions 42, and a plurality of wave troughs respectively serving as the outer radial recesses 44.

In some examples, the inner radial recesses 34 may be respectively aligned with the outer radial protrusions 42 in a radial direction (R) perpendicular to the axis (A). In some examples, the inner radial protrusions 32 may be respectively aligned with the outer radial recesses 44 in the radial direction (R).

FIG. 10 is a partial rear sectional view of the example lower tubes 1314, 1316 and the example upper tubes 1310, 1312. Specifically, each of the lower tubes 1314, 1316 is mounted with a first bushing 2 and a second bushing 2’ (e.g., an upper bushing and a lower bushing). Each of the upper tubes 1310, 1312 extends through the upper bushing 2 and the lower bushing 2’ in the respective one of the lower tubes 1314, 1316. The bushings 2, 2’ serve to facilitate smooth relative movement between the upper tubes 1310, 1312 and the lower tubes 1314, 1316. For example, the bushings 2, 2’ may ensure alignment, appropriate tolerance, and/or lubrication between the upper tubes 1310, 1312, and the lower tubes 1314, 1316.

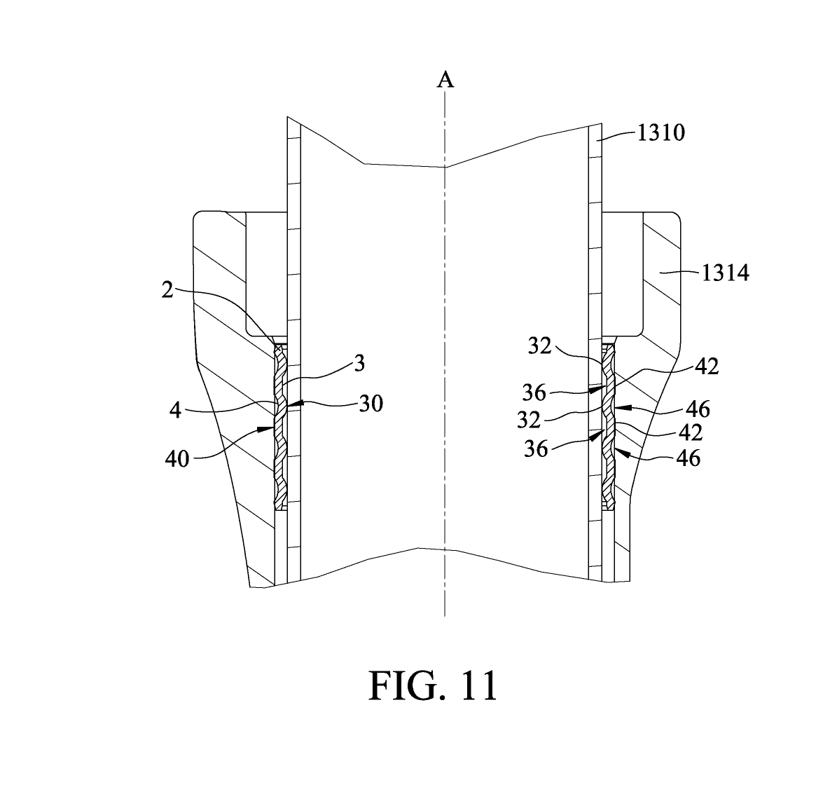

FIG. 11 is an enlarged view of FIG. 10. For example, the inner contact interface 30 of the inner structure 3 may be in slidable contact with an outer surface of the upper tube 1310. The outer contact interface 40 of the outer structure 4 may be press-fit into the lower tube 1314. In this example, the inner contact interface 30 may be made of Polytetrafluoroethylene. In some examples, the outer contact interface 40 may serve as a flexible bushing clearance element that facilitates radial movement relative to the axis (A) between the lower tube 1314 and the upper tube 1310. Specifically, by virtue of the configuration of the outer structure 4 (including the outer radial protrusions and the outer radial recesses that are arranged along the axis (A) in an alternating arrangement), the outer contact interface 40 may have flexibility in the radial direction to facilitate radial movement, for example alignment. Therefore, when the example bushing 2 is press-fit into the lower tube 1314 such that the outer contact interface 40 is squeezed, the inner structure 3 may not be significantly twisted or bent, or may not be twisted or bent, so an effective inner diameter of the example bushing 2 may not be reduced. Thus, the inner contact interface 30 of the example bushing 2 may not need to undergo additional processes, for example a reaming process, for fitting the upper tube 1310.

In some examples, the inner contact interface 30 may serve as a flexible bushing clearance element that facilitates radial movement relative to the axis (A) between the lower tube 1314 and the upper tube 1310. Specifically, by virtue of the configuration of the inner structure 3 (including the inner radial protrusions and the inner radial recesses that are arranged along the axis (A) in an alternating arrangement), the inner contact interface 30 may have flexibility in the radial direction to facilitate radial movement, for example alignment. Therefore, even if a through hole defined by the inner contact interface 30 is not perfectly aligned with the upper tube 1310 along the axis (A), when the upper tube 1310 extends through the example bushing 2, the inner contact interface 30 may be easily deformed by the upper tube 1310 to fit the outer profile of the upper tube 1310 without significantly impeding the relative movement between the upper tube 1310 and the lower tube 1314. Accordingly, the inner contact interface 30 and the outer contact interface 40 of the example bushing 2 may achieve a self-aligning effect.

In some examples, the inner structure 3 and/or the outer structure 4 may further include one or more retention features. For example, as shown in FIG. 11, the inner structure 3 may include a plurality of inner retention features 36 that serve as inner lubrication retention features. Each of the plurality of inner retention features 36 is defined between two adjacent ones of the inner radial protrusions 32. The inner retention features 36 may be variously configured for retaining lubricant, for example by tuning a surface roughness or texture or otherwise sizing and/or shaping the inner retention features 36 to retain an intended liquid or solid lubricant. The inner retention features 36 ensure local lubrication at the bushing 2 to further facilitate smooth relative movement between the upper tube 1310 and the lower tube 1314. In some examples, the outer structure 4 may include a plurality of outer retention features 46. Each of the plurality of outer retention features 46 is defined between two adjacent ones of the outer radial protrusions 42. The outer retention features 46 may be variously configured for retaining adhesive or lubricant, for example by tuning a surface roughness or texture or otherwise sizing and/or shaping the outer retention features 46.

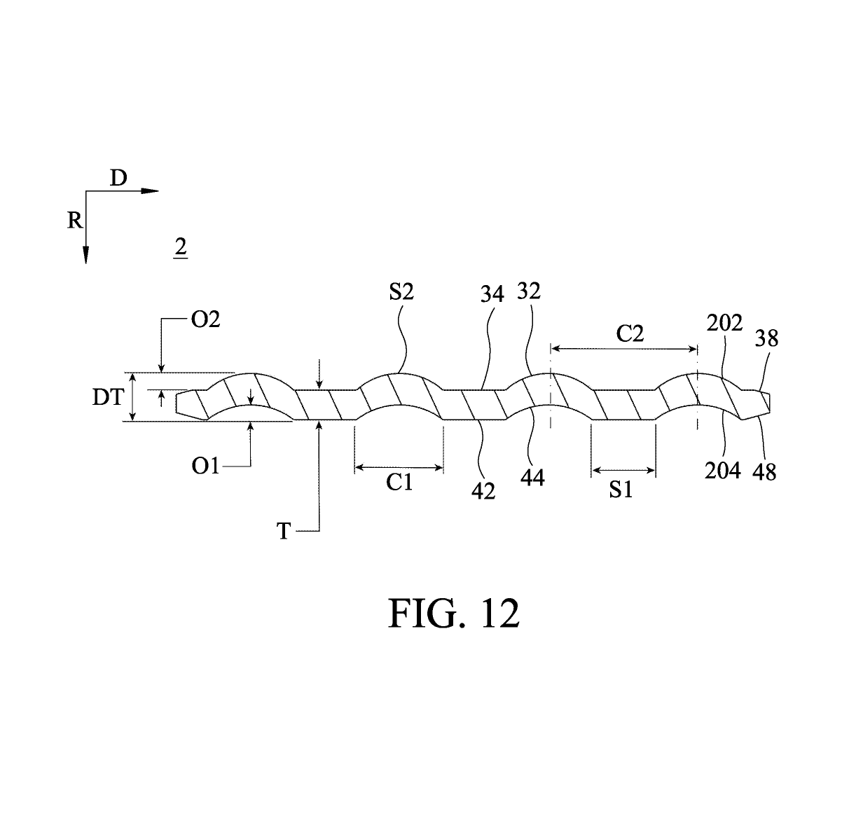

FIG. 12 is a partial sectional view of an example bushing before being assembled with suspension components. In some examples, the outer surrounding surface 204 of the bushing 2 may have at least one outer guide section 48 that is located at one of two opposite ends of the bushing 2 in a direction (D) of the axis (A, see FIG. 3) and that tapers away from another one of the opposite ends of the bushing 2. By virtue of the outer guide section 48, the example bushing 2 may be easily inserted into a first suspension element (e.g., the lower tube 1314 in FIG. 11). In some examples, the outer guide section 48 may be configured as a frustoconical surface that tapers away from another one of the opposite ends of the bushing 2. In some examples, the outer surrounding surface 204 of the bushing 2 may have two outer guide sections 48 that are respectively located at the opposite ends of the bushing 2 and that taper away from each other.

In some examples, the inner surrounding surface 202 of the bushing 2 may have at least one inner guide section 38 that is located at one of the opposite ends of the bushing 2 and that tapers toward another one of the opposite ends of the bushing 2. By virtue of the inner guide section 38, a second suspension element (e.g., the upper tube 1310 in FIG. 11) may be easily inserted into the example bushing 2. In some examples, the inner guide section 38 may be configured as a frustoconical surface that tapers toward another one of the opposite ends of the bushing 2. In some examples, the inner surrounding surface 202 of the bushing 2 may have two inner guide sections 38 that are respectively located at the opposite ends of the bushing 2 and that taper toward each other.

In some examples, before the bushing is assembled with suspension elements, a vertex of each of the outer radial protrusions 42 serves as a free outer contact section (S1) for contact with a first suspension element (e.g., the lower tube 1314 in FIG. 11). In some examples, free outer contact section (S1) may be configured as a cylindrical surface. A vertex of each of the inner radial protrusions 32 serves as a free inner contact section (S2) for contact with a second suspension element (e.g., the upper tube 1310 in FIG. 11). Before the example bushing 2 is assembled with the suspension elements, the example bushing 2 may have a free outer clearance (C1) that is defined between two adjacent ones of the free outer contact sections (S1). The example bushing 2 may further have a free inner clearance (C2) that is defined between two adjacent ones of the free inner contact sections (S2).

In some examples, before the bushing 2 is assembled with the suspension elements, various distances and/or dimensions may be defined. For example, a distance between one of the free outer contact sections (S1) and one of the free inner contact sections (S2) in the radial direction (R) may be defined as a free bushing total dimension (DT). A distance between one of the free outer contact sections (S1) and a radially inner end of one of the outer radial recesses 44 in the radial direction (R) may be defined as a free outer offset (O1). A distance between one of the free inner contact sections (S2) and a radially outer end of one of the inner radial recesses 34 in the radial direction (R) may be defined as a free inner offset (O2). A distance between one of the free outer contact sections (S1) and a radially outer end of one of the inner radial recesses 34 in the radial direction (R) may be defined as a free wall thickness (T). It should be appreciated that the dimensions may be defined in various other ways. For example, the free wall thickness (T) may also be defined as a material thickness before a forming process and/or a material thickness maintained after a forming process. In an example, the free wall thickness (T) is defined as a material thickness of the bushing 2, for example a total material thickness of metal and Polytetrafluoroethylene as described below.

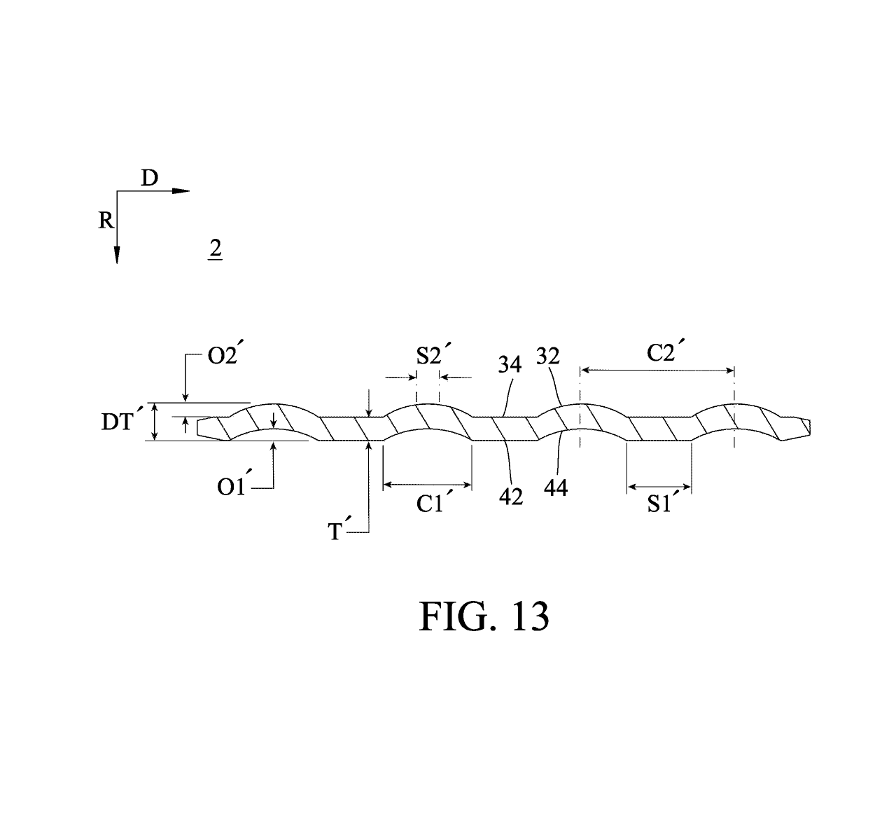

FIG. 13 is a partial sectional view of the example bushing in FIG. 12 after being assembled with suspension components. After the example bushing 2 is assembled with suspension elements, the vertex of each of the outer radial protrusions 42 is in contact with a first suspension element (e.g., the lower tube 1314 in FIG. 11), and serves as an assembled outer contact section (S1’). The vertex of each of the inner radial protrusions 32 is in contact with a second suspension element (e.g., the upper tube 1310 in FIG. 11), and serves as an assembled inner contact section (S2’). An extent of the assembled outer contact section (S1’) of the example bushing 2 in the direction (D) of the axis (A) is greater than an extent of the free outer contact section (S1) of the example bushing 2 in the direction (D) of the axis (A). An extent of the assembled inner contact section (S2’) of the example bushing 2 in the direction (D) of the axis (A) is greater than an extent of the free inner contact section (S2) of the example bushing 2 in the direction (D) of the axis (A).

In some examples, at least a portion of the assembled outer contact sections (S1’) is fixedly positioned relative to the first suspension element, and at least a portion of the assembled inner contact sections (S2’) is in slidable contact with the second suspension element. In some examples, an extent of one of the assembled outer contact sections (S1’) in the direction (D) of the axis (A, see FIG. 3) may be greater than an extent of one of the assembled inner contact sections (S2’) in the direction (D) of the axis (A).

After the example bushing 2 is assembled with the suspension elements, the example bushing 2 may have an assembled outer clearance (C1’) that is defined between two adjacent ones of the assembled outer contact sections (S1’). The example bushing 2 may further have an assembled inner clearance (C2’) that is defined between two adjacent ones of the assembled inner contact sections (S2’). In some examples, an extent of the assembled outer clearance (C1’) of the example bushing 2 in the direction (D) of the axis (A) is greater than an extent of the free outer clearance (C1) of the example bushing 2 in the direction (D) of the axis (A). An extent of the assembled inner clearance (C2’) of the example bushing 2 in the direction (D) of the axis (A) may be different from or may be the same as an extent of the free inner clearance (C2) of the example bushing 2 in the direction (D) of the axis (A). In some examples, an extent of the assembled inner clearance (C2’) in the direction (D) of the axis (A) may be greater than an extent of the assembled outer clearance (C1’) of the example bushing 2 in the direction (D) of the axis (A).

In some examples, after the bushing 2 is assembled with the suspension elements, a distance between one of the assembled outer contact sections (S1’) and one of the assembled inner contact sections (S2’) in the radial direction (R) is defined as an assembled bushing total dimension (DT’), a distance between one of the assembled outer contact sections (S1’) and a radially inner end of one of the outer radial recesses 44 in the radial direction (R) is defined as an assembled outer offset (O1’), a distance between one of the assembled inner contact sections (S2’) and a radially outer end of one of the inner radial recesses 34 in the radial direction (R) is defined as an assembled inner offset (O2’), and a distance between one of the assembled outer contact sections (S1’) and a radially outer end of one of the inner radial recesses 34 in the radial direction (R) is defined as an assembled wall thickness (T’). The assembled bushing total dimension (DT’), the assembled outer offset (O1’), the assembled inner offset (O2’) and the assembled wall thickness (T’) are respectively smaller than the free bushing total dimension (DT), the free outer offset (O1), the free inner offset (O2) and the free wall thickness (T).

Referring back to FIG. 11, in some examples, the upper tube 1310 may be press-fit into the inner contact interface 30 of the inner structure 3, and the outer contact interface 40 of the outer structure 4 may be in slidable contact with the lower tube 1314. In this example, the outer contact interface 40 may be made of Polytetrafluoroethylene. In various examples, the outer structure 4 may further include a plurality of outer retention features 46. Each of the plurality of outer retention features 46 is defined between two adjacent ones of the outer radial protrusions 42, and serves as an outer lubrication retention feature. The outer retention features 46 may be variously configured for retaining lubricant, for example by tuning a surface roughness or texture or otherwise sizing and/or shaping the outer retention features 46 to retain an intended liquid or solid lubricant. The outer retention features 46 ensure local lubrication at the bushing 2 to further facilitate smooth relative movement between the upper tube 1310 and the lower tube 1314. In some examples, the inner structure 3 may include a plurality of inner retention features 36. The inner retention features 36 may be variously configured for retaining adhesive or lubricant, for example by tuning a surface roughness or texture or otherwise sizing and/or shaping the inner retention features 36.

Another example suspension front fork may be configured such that an upper tube thereof has an interior wall defining an interior volume therein, and a lower tube thereof is movable along an axis at least in part within the interior volume of the upper tube. The bushing 2 according to the disclosure may also be used in such example suspension front fork to facilitate smooth relative movement between the example lower and upper tubes.

In some examples, the bushing 2 may be formed from a metal strip applied with a Polytetrafluoroethylene layer. The metal strip may be made of stainless steel, aluminum, iron, etc.

In summary, by virtue of the configuration of the inner contact interface 30 and/or the outer contact interface 40, the bushing 2 according to the disclosure has flexibility in the radial direction, so as to achieve a self-aligning effect. In addition, by virtue of the slot 22 of the bushing body 20 (see FIG. 3), the bushing may be fitted into a tubular suspension element easily. The bushing according to the disclosure may also be used in the rear shock absorber and/or the dropper seat post of a bicycle.

The embodiments described herein may be provided with any of the features and elements as shown and described. The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations and/or acts are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that any described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

Further aspects are provided by the following examples and example combinations:

Example 1 is a bushing including a bushing body. The bushing body is disposed about an axis, and has an inner surrounding surface, and an outer surrounding surface that is opposite to the inner surrounding surface. The inner surrounding surface of the bushing body has an inner structure that includes a plurality of inner radial protrusions and a plurality of inner radial recesses. The inner radial protrusions and the inner radial recesses are arranged along the axis in an alternating arrangement. The inner radial protrusions cooperatively form an inner contact interface.

Example 2 includes the bushing of Example 1, wherein the outer surrounding surface of the bushing body comprises an outer structure that includes a plurality of outer radial protrusions and a plurality of outer radial recesses. The outer radial protrusions and the outer radial recesses are arranged along the axis in an alternating arrangement. The outer radial protrusions cooperatively form an outer contact interface.

Example 3 includes the bushing of Example 2, wherein the inner radial recesses are respectively aligned with the outer radial protrusions in a radial direction perpendicular to the axis.

Example 4 includes the bushing of Examples 2 or 3, wherein the inner radial protrusions are respectively aligned with the outer radial recesses in a radial direction perpendicular to the axis.

Example 5 includes the bushing of any of Examples 1 to 4, wherein the bushing body further has a slot formed therethrough.

Example 6 includes the bushing of any of Examples 1 to 5, wherein the outer surrounding surface of the bushing body has at least one outer guide section that is located at one of two opposite ends of the bushing along the axis and that tapers away from another one of the opposite ends of the bushing.

Example 7 includes the bushing of any of Examples 1 to 6, wherein the inner surrounding surface of the bushing body has at least one inner guide section that is located at one of two opposite ends of the bushing along the axis and that tapers toward another one of the opposite ends of the bushing.

Example 8 includes the bushing of any of Examples 1 to 7, wherein the inner structure further includes a plurality of inner lubrication retention features. Each of the inner lubrication retention features is defined between two adjacent ones of the inner radial protrusions.

Example 9 includes the bushing of any of Examples 1 to 8, wherein the inner contact interface is made of Polytetrafluoroethylene.

Example 10 is a suspension arrangement adapted to facilitate relative movement, and having a first suspension element, a second suspension element and a bushing body. The second suspension element is movable along an axis within at least a portion of the first suspension element. The bushing body is disposed between the first suspension element and the second suspension element. The bushing body has an inner surrounding surface, and an outer surrounding surface that is opposite to the inner surrounding surface. The outer surrounding surface of the bushing body has an outer structure that includes a plurality of outer radial protrusions and a plurality of outer radial recesses. The outer radial protrusions and the outer radial recesses are arranged along the axis in an alternating arrangement. The outer radial protrusions cooperatively form an outer contact interface. The outer contact interface is in contact with the first suspension element.

Example 11 includes the suspension arrangement of Example 10, wherein the inner surrounding surface of the bushing body comprises an inner structure that includes a plurality of inner radial protrusions and a plurality of inner radial recesses, the inner radial protrusions and the inner radial recesses being arranged along the axis in an alternating arrangement, the inner radial protrusions cooperatively form an inner contact interface that is in contact with the second suspension element.

Example 12 includes the suspension arrangement of Example 11, wherein at least one of the outer contact interface and the inner contact interface is in slidable contact with the respective one of the first suspension element and the second suspension element.

Example 13 includes the suspension arrangement of any of Examples 11 to 12, wherein the one of the inner contact interface and the outer contact interface is made of Polytetrafluoroethylene.

Example 14 includes the suspension arrangement of any of Examples 11 to 13, wherein one of the inner contact interface and the outer contact interface has at least one contact section that is in slidable contact with the respective one of the first suspension element and the second suspension element. Another one of the inner contact interface and the outer contact interface has at least one of contact section that is fixedly positioned relative the respective one of the first suspension element and the second suspension element. An extent of the at least one contact section of the one of the inner contact interface or the outer contact interface along the axis is greater than an extent of the at least one contact section of another one of the inner contact interface or the outer contact interface along the axis.

Example 15 includes the suspension arrangement of any of Examples 11 to 14, wherein the inner contact interface is in slidable contact with the second suspension element, the inner structure further includes a plurality of inner lubrication retention features each of which is defined between two adjacent ones of the inner radial protrusions.

Example 16 includes the suspension arrangement of any of Examples 10 to 15, wherein the outer surrounding surface of the bushing body has at least one outer guide section that is located at one of two opposite ends of the bushing body along the axis and that tapers away from another one of the opposite ends of the bushing body.

Example 17 includes the suspension arrangement of any of Examples 10 to 16, wherein the inner surrounding surface of the bushing body has at least one inner guide section that is located at one of two opposite ends of the bushing body along the axis and that tapers toward another one of the opposite ends of the bushing body.

Example 18 includes the suspension arrangement of any of Examples 10 to 17, wherein the outer contact interface is in slidable contact with the first suspension element, the outer structure further includes a plurality of outer lubrication retention features, each of which is defined between two adjacent ones of the outer radial protrusions.

Example 19 includes the suspension arrangement of any of Examples 10 to 18, wherein the bushing body further has a slot formed therethrough and extending in an axial direction relative to the axis.

Example 20 is a suspension arrangement including a first suspension element, a second suspension element, a first bushing and a second bushing. The first suspension element has an interior wall defining an interior volume between a first end and a second end thereof. The second suspension element is movable along an axis at least in part within the interior volume of the first suspension element. The first bushing is disposed between the first suspension element and the second suspension element. The first bushing includes at least one flexible first bushing clearance element facilitating radial movement relative to the axis between the first suspension element and the second suspension element. The second bushing is disposed between the first suspension element and the second suspension element, and is spaced apart between the first bushing and the second end of the first suspension element. The second bushing includes at least one flexible second bushing clearance element facilitating radial movement relative to the axis between the first suspension element and the second suspension element.

What is claimed is:

1. A bushing comprising:
a bushing body disposed about an axis and having an inner surrounding surface and an outer surrounding surface that is opposite to the inner surrounding surface, the inner surrounding surface of the bushing body having an inner structure that includes a plurality of inner radial protrusions and a plurality of inner radial recesses, the inner radial protrusions and the inner radial recesses being arranged along the axis in an alternating arrangement, wherein the inner radial protrusions cooperatively form an inner contact interface.

2. The bushing as claimed in claim 1, wherein the outer surrounding surface of the bushing body comprises an outer structure that includes a plurality of outer radial protrusions and a plurality of outer radial recesses, the outer radial protrusions and the outer radial recesses being arranged along the axis in an alternating arrangement, the outer radial protrusions cooperatively forming an outer contact interface.

3. The bushing as claimed in claim 2, wherein the inner radial recesses are respectively aligned with the outer radial protrusions in a radial direction perpendicular to the axis.

4. The bushing as claimed in claim 2, wherein the inner radial protrusions are respectively aligned with the outer radial recesses in a radial direction perpendicular to the axis.

5. The bushing as claimed in claim 1, wherein the bushing body further has a slot formed therethrough.

6. The bushing as claimed in claim 1, wherein the outer surrounding surface of the bushing body has at least one outer guide section that is located at one of two opposite ends of the bushing along the axis and that tapers away from another one of the opposite ends of the bushing.

7. The bushing as claimed in claim 1, wherein the inner surrounding surface of the bushing body has at least one inner guide section that is located at one of two opposite ends of the bushing along the axis and that tapers toward another one of the opposite ends of the bushing.

8. The bushing as claimed in claim 1, wherein the inner structure further includes a plurality of inner retention features, each of which is defined between two adjacent ones of the inner radial protrusions.

9. The bushing as claimed in claim 1, wherein the inner contact interface is made of Polytetrafluoroethylene.

10. A suspension arrangement adapted to facilitate relative movement, comprising:
a first suspension element;
a second suspension element, wherein the second suspension element is movable along an axis within at least a portion of the first suspension element; and
a bushing body disposed between the first suspension element and the second suspension element, the bushing body having an inner surrounding surface, and an outer surrounding surface that is opposite to the inner surrounding surface, the outer surrounding surface of the bushing body having an outer structure that includes a plurality of outer radial protrusions and a plurality of outer radial recesses, the outer radial protrusions and the outer radial recesses being arranged along the axis in an alternating arrangement, the outer radial protrusions cooperatively forming an outer contact interface, the outer contact interface being in contact with the first suspension element.

11. The suspension arrangement as claimed in claim 10, wherein the inner surrounding surface of the bushing body comprises an inner structure that includes a plurality of inner radial protrusions and a plurality of inner radial recesses, the inner radial protrusions and the inner radial recesses being arranged along the axis in an alternating arrangement, the inner radial protrusions cooperatively forming an inner contact interface that is in contact with the second suspension element.

12. The suspension arrangement as claimed in claim 11, wherein at least one of the outer contact interface or the inner contact interface is in slidable contact with a respective one of the first suspension element or the second suspension element.

13. The suspension arrangement as claimed in claim 12, wherein the at least one of the inner contact interface or the outer contact interface is made of Polytetrafluoroethylene.

14. The suspension arrangement as claimed in claim 12, wherein one of the outer contact interface or the inner contact interface has at least one contact section that is in slidable contact with the respective one of the first suspension element or the second suspension element, another one of the outer contact interface or the inner contact interface having at least one of contact section that is fixedly positioned relative the respective one of the first suspension element or the second suspension element, an extent of the at least one contact section of the one of the inner contact interface or the outer contact interface along the axis being greater than an extent of the at least one contact section of the other one of the inner contact interface or the outer contact interface along the axis.

15. The suspension arrangement as claimed in claim 11, wherein the inner contact interface is in slidable contact with the second suspension element, the inner structure further including a plurality of inner retention features each of which is defined between two adjacent ones of the inner radial protrusions.

16. The suspension arrangement as claimed in claim 10, wherein the outer surrounding surface of the bushing body has at least one outer guide section that is located at one of two opposite ends of the bushing body along the axis and that tapers away from another one of the opposite ends of the bushing body.

17. The suspension arrangement as claimed in claim 10, wherein the inner surrounding surface of the bushing body has at least one inner guide section that is located at one of two opposite ends of the bushing body along the axis and that tapers toward another one of the opposite ends of the bushing body.

18. The suspension arrangement as claimed in claim 10, wherein the outer contact interface is in slidable contact with the first suspension element, the outer structure further including a plurality of outer retention features, each of which is defined between two adjacent ones of the outer radial protrusions.

19. The suspension arrangement as claimed in claim 10, wherein the bushing body further has a slot formed therethrough and extending in an axial direction relative to the axis.

20. A suspension arrangement for a bicycle, the suspension arrangement comprising:
a first suspension element having an interior wall defining an interior volume between a first end and a second end thereof;
a second suspension element movable along an axis at least in part within the interior volume of the first suspension element;
a first bushing disposed between the first suspension element and the second suspension element, the first bushing comprising at least one flexible first bushing clearance element facilitating radial movement relative to the axis between the first suspension element and the second suspension element; and
a second bushing disposed between the first suspension element and the second suspension element and spaced apart between the first bushing and the second end of the first suspension element, the second bushing comprising at least one flexible second bushing clearance element facilitating radial movement relative to the axis between the first suspension element and the second suspension element.
